(19) United States
(12) Patent Application Publication
(10) Pub. No.: US 2022/0343455 A1
(43) Pub. Date: Oct. 27, 2022

(54) SPLIT PIXEL ARCHITECTURE FOR IMAGE PROCESSING

(71) Applicant: QUALCOMM Incorporated, San Diego, CA (US)

(72) Inventors: Nageswara Rao Vavintaparthi, Bangalore (IN); Venkatesh Hanamsagar, Bangalore (IN); Raghavendra Prasad Nerlige Onkarappa, Bangalore (IN); Joby Abraham, Bangalore (IN)

(21) Appl. No.: 17/236,318

(22) Filed: Apr. 21, 2021

(51) Int. Cl. G06T 1/20; G06T 5/50; G06T 1/60; H04N 5/232

(52) U.S. Cl. CPC G06T 1/20; G06T 5/50; G06T 1/60; H04N 5/23229

(57) ABSTRACT

An example image processor for processing pixels includes processing circuitry configured to determine that a first subset of input bits of a current pixel are the same as a first subset of input bits of a previously processed pixel, selectively bypass processing the first subset of input bits through a first pipeline based on the determination, output a first subset of output bits of the previously processed pixel as a first subset of output bits of the current pixel based on the determination, and merge the first subset of output bits of the current pixel with a second subset of output bits of the current pixel generated through a second pipeline from a second subset of input bits of the current pixel.

### TECHNICAL FIELD

This disclosure relates to capture or image processing.

### BACKGROUND

A camera device includes one or more cameras that capture frames (e.g., images). Examples of the camera device include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” or any device with digital imaging or video capabilities.

The captured frame includes a plurality of pixels (also called samples). One or more processors of the camera device processes the pixels of the frames to generate image content that is output for display.

### SUMMARY

In general, this disclosure describes techniques for utilizing multi-processing pipelines that each process a subset of bits of a plurality of bits of a pixel of a frame, and selectively bypassing the processing of a subset of bits via one of the processing pipelines based on comparison of bits to previously processed proximate pixels. For example, an image signal processing (ISP) block includes two processing pipelines: a first processing pipeline configured to process most significant bits (MSBs) of input bits and a second processing pipeline configured to process least significant bits (LSBs) of the input bits. In some examples, if the MSBs of input bits for a current pixel are the same as the MSBs of input bits for a proximate pixel that was previously processed, then it may be possible to bypass processing the MSBs of the input bits through the first processing pipeline. In such examples, the MSBs of the output bits for the proximate pixel that was previously processed may be re-used as the MSBs of the output bits for the current pixel. By bypassing the first processing pipeline, there may be a reduction in power consumption.

In one example, this disclosure describes an image processor for processing pixels includes a first pipeline configured to selectively process respective first subsets of input bits of pixels to generate respective first subsets of output bits; a second pipeline configured to process respective second subsets of the input bits of the pixels to generate respective second subsets of output bits; and processing circuitry configured to: determine that a first subset of input bits of a current pixel are the same as a first subset of input bits of a previously processed pixel; selectively bypass processing the first subset of input bits of the current pixel through the first pipeline based on the determination that the first subset of input bits of the current pixel are the same as the first subset of input bits of the previously processed pixel; output a first subset of output bits of the previously processed pixel as a first subset of output bits of the current pixel based on the determination that the first subset of input bits of the current pixel are the same as the first subset of input bits of the previously processed pixel; and merge the first subset of output bits of the current pixel with a second subset of output bits of the current pixel generated through the second pipeline from a second subset of input bits of the current pixel.

In another example, this disclosure describes a method of processing pixels includes determining that a first subset of input bits of a current pixel are same as a first subset of input bits of a previously processed pixel; selectively bypassing processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits; outputting a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and merging the first subset of output bits of the current pixel with a second subset of output bits of the current pixel generated through the second pipeline from a second subset of input bits of the current pixel.

In another example, this disclosure describes a device for processing pixels includes means for determining that a first subset of input bits of a current pixel are same as a first subset of input bits of a previously processed pixel; means for selectively bypassing processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits; means for outputting a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and means for merging the first subset of output bits of the current pixel with a second subset of output bits of the current pixel generated through the second pipeline from a second subset of input bits of the current pixel.

In another example, this disclosure describes a computer-readable storage medium storing instructions thereon that when executed cause one or more processors to: determine that a first subset of input bits of a current pixel are same as a first subset of input bits of a previously processed pixel; selectively bypass processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits; output a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and merge the first subset of output bits of the current pixel with a second subset of output bits of the current pixel generated through the second pipeline from a second subset of input bits of the current pixel.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a block diagram illustrating a processing block of a camera processor of FIG. 1 in greater detail.

FIG. 3 is a block diagram illustrating a merge circuit of the processing block of FIG. 2 in greater detail.

FIGS. 4A and 4B are conceptual diagram illustrating examples of a first pipeline and a second pipeline for pixel processing in accordance with one or more examples described in this disclosure.

FIG. 5 is a flowchart illustrating an example method of operation in accordance with one or more examples described in this disclosure.

FIG. 6 is a flowchart illustrating another example method of operation in accordance with one or more examples described in this disclosure.

### DETAILED DESCRIPTION

The example techniques described in this disclosure relate to utilizing two or more processing pipelines within an image signal processing (ISP) block, where each of the processing pipelines processes a subset of bits of the total number of bits used to represent a pixel. For processing frames captured by a camera, an ISP block receives bits that represent pixel values for a pixel of a frame. As an example, there may be 16 bits per pixel (16 BPP), where 16 bits represent the pixel value (e.g., value for a red-component, green-component, or blue-component) for a pixel. The ISP block processes 16 input bits of a pixel and outputs 16 output bits of the pixel, and the 16 output bits may be the 16 input bits for the next ISP block.

In one or more examples described in this disclosure, an ISP block includes a first pipeline configured to process the first M bits (e.g., the M most significant bits) of the N total bits used to represent the pixel value of a pixel (e.g., first 5 most significant bits of the 16 bits) and a second pipeline configured to process the remaining bits of the N bits (e.g., last 11 least significant bits of the 16 bits). The first pipeline may be referred to as the most significant bit (MSB) pipeline and the second pipeline may be referred to as the least significant bit (LSB) pipeline.

In some examples, the pixel values of proximate pixels, including neighboring pixels, are approximately the same. Proximate pixels may be pixels that separated by one or more pixels from a current pixel, and neighboring pixels may be pixels that are next to the current pixel, and not separated by other pixels. For example, there may be changes in the lowest significant bits (LSBs), but the most significant bits (MSBs) may be the same. In such examples, it may be possible to process only the LSBs using the LSB pipeline, and copy the MSBs from a proximate pixel. In this way, processing through the MSB pipeline can be skipped, resulting in the reduction of processing power.

As described above, an ISP block receives input bits for a pixel and generates output bits for the pixel. In one or more examples, the ISP block may split the input bits into input MSBs (e.g., first 5 most significant bits of 16 bits) and input LSBs (e.g., last 11 least significant bits of 16 bits), and generate output MSBs (e.g., first 5 most significant bits of 16 bits) via the MSB pipeline and output LSBs (e.g., last 11 least significant bits of 16 bits) via the LSB pipeline that are combined together to generate the output bits.

For the MSB pipeline, the ISP block may store input MSBs and output MSBs of one or more previously processed proximate pixels. For a current pixel, a comparator block may compare the input MSBs of one or more previously processed proximate pixels to the input MSBs of the current pixel. If the input MSBs of one of the previously processed proximate pixels is the same as the input MSBs for the current pixel, rather than processing the MSBs for the current pixel, a multiplexer may select the output MSBs of the previously processed proximate pixel having the same input MSBs as the input MSBs for the current pixel. A merge circuit may combine the selected output MSBs and the output LSBs from the LSB pipeline. For example, the LSB pipeline may process the LSBs of the current pixel through the combinational logic of the LSB pipeline, but it may be possible to avoid processing the MSBs for the current pixel through the combinational logic of the MSB pipeline. Instead, the output MSBs of a previously processed proximate pixel may be utilized as the output MSBs for the current pixel that are combined with the output from the LSB pipeline.

The example techniques described in this disclosure may also be utilized in examples where there are multiple sensors. In examples with multiple sensors, the bit depth (e.g., number of bits used to represent a pixel) may be different for different sensors (e.g., a first sensor utilizes 16 bits per pixel and a second sensor utilizes 10 bits per pixel). In some examples, the number of bits that the LSB pipeline processes may be equal to or less than the bit depth of a sensor. In such examples, when processing pixels from the sensor, it may be possible to bypass the MSB pipeline altogether, further saving processing power.

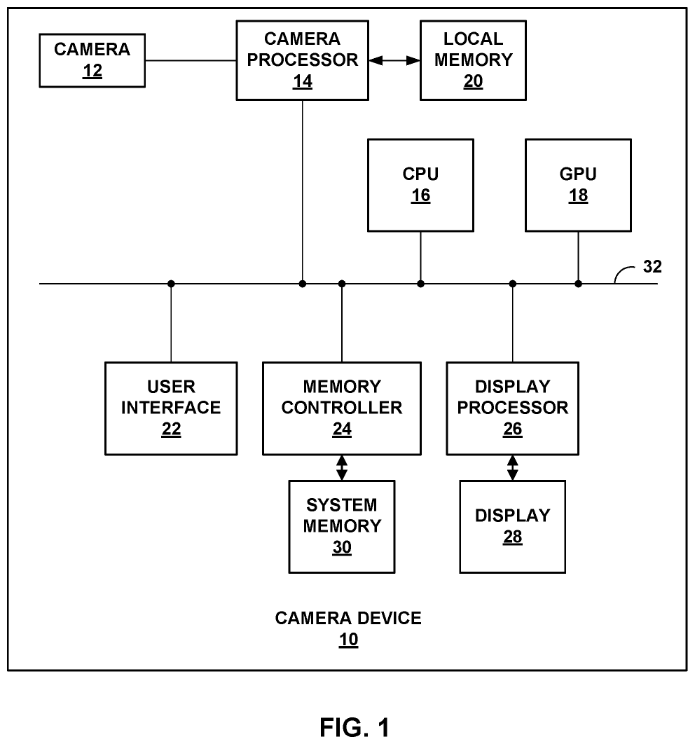

FIG. 1 is a block diagram of a device configured to perform one or more of the example techniques described in this disclosure. Examples of camera device 10 include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” or any device with digital imaging or video capabilities.

As illustrated in the example of FIG. 1, camera device 10 includes camera 12 (e.g., having an image sensor and lens), camera processor 14 and local memory 20 of camera processor 14, a central processing unit (CPU) 16, a graphical processing unit (GPU) 18, user interface 22, memory controller 24 that provides access to system memory 30, and display processor 26 that outputs signals that cause graphical data to be displayed on display 28. Although the example of FIG. 1 illustrates camera device 10 including one camera 12, in some examples, camera device 10 may include a plurality of cameras 12, such as for omnidirectional image or video capture. Also, although camera device 10 is illustrated as including one camera processor 14, in some examples, there may be a plurality of camera processors (e.g., one for each of cameras 12).

Also, although the various components are illustrated as separate components, in some examples the components may be combined to form a system on chip (SoC). As an example, camera processor 14, CPU 16, GPU 18, and display processor 26 may be formed on a common integrated circuit (IC) chip. In some examples, one or more of camera processor 14, CPU 16, GPU 18, and display processor 26 may be in separate IC chips. Additional examples of components that may be configured to perform the example techniques include a digital signal processor (DSP). Various other permutations and combinations are possible, and the techniques should not be considered limited to the example illustrated in FIG. 1.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 20 and system memory 30 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Camera processor 14 is configured to receive image frames from camera 12, and process the image frames to generate output frames for display. CPU 16, GPU 18, camera processor 14, or some other circuitry may be configured to process the output frame that includes image content generated by camera processor 14 into images for display on display 28. In some examples, GPU 18 may be further configured to render graphics content on display 28.

In some examples, camera processor 14 may be configured as a plurality of parallel processing paths. For instance, camera processor 14 may include a camera interface that interfaces between camera 12 and camera processor 14. Camera processor 14 may include additional circuitry to process the image content. Camera processor 14 outputs the resulting frames with image content (e.g., pixel values for each of the image pixels) to system memory 30 via memory controller 24.

An example of a pixel value may be the value of a red-component, green-component, or blue-component in a red-green-blue (RGB) color space. However, the example techniques are not limited, and the pixel value for a pixel may be various values (e.g., opacity) used to define the pixel.

For example, camera processor 14 may receive pixels of frames captured by camera 12. Each of the processing paths of camera processor 14 may process a pixel of the pixels of the captured frames (e.g., input pixels) to generate pixels for frames for display (e.g., output pixels). In some examples, the processing paths of camera processor 14 may perform operations such as filtering, blending, stitching, Bayer transformation, demosaicing, noise reduction, and image sharpening, as a few examples.

Each of the processing paths of camera processor 14 may be configured as a plurality of processing blocks that are sequentially connected together. For example, a first processing path of camera processor 14 may include a first set of sequentially connected processing blocks, a second processing path of camera processor 14 may include a second set of sequentially connected processing blocks, and so forth.

As described in more detail, in accordance with one or more examples described in this disclosure, a processing block of a processing path may include two or more pipelines that are each configured to process a subset of input bits of a pixel of a frame. For example, each pixel of a captured frame may be represented by a pixel value having 16 bits (e.g., 16 bits-per-pixel, or 16 BPP). A processing block of a processing path of camera processor 14 may include a first pipeline to process a first subset of the input bits (e.g., 5 most significant bits (MSBs) of the 16 input bits) and a second pipeline to process a second subset of the input bits (e.g., 11 least significant bits (LSBs) of the 16 input bits). The processing block including two pipelines is one example, and there may be more pipelines than two. Also, splitting the 16 input bits into 5 MSBs and 11 LSBs is one example, and the number of MSBs and LSBs may be different than 5 and 11.

There being 16 input bits of a pixel is also one example. As described in more detail, in some cases, there may be fewer than 16 input bits for a pixel (e.g., 10 input bits). In general, the number of input bits for a pixel may be based on the type of camera 12. Also, the number of bits that form the MSBs and the number of bits that form the LSBs may be tunable or defined at the time of designing or manufacturing. For instance, 5 MSBs and 11 LSBs is one example, and there may be other examples (e.g., 6 MSBs and 10 LSBs or 8 MSBs and 8 LSBs or 9 MSBs and 7 LSBs).

By utilizing two or more pipelines for a processing block of a processing path of camera processor 14, rather than a single pipeline, this disclosure describes example techniques to reuse previously determined output bits for a previously processed pixel, rather than recalculating all of the output bits for a current pixel. For instance, the input to a processing block may be input bits of a current pixel, and the output of the processing block may be output bits of the current pixel.

A splitter circuit of the processing block may split the input bits into a first subset of input bits and a second subset of input bits, and possibly more subsets based on the number of pipelines in the processing block. A first pipeline of the two or more pipelines of the processing block may be configured to process the first subset of the input bits and output a first subset of output bits. A second pipeline of the two or more pipelines of the processing block may be configured to process the second subset of the input bits and output a second subset of output bits. A merge circuit may be configured to merge the first subset of output bits and the second subset of output bits to generate the output bits for the processing block.

In accordance with one or more examples described in this disclosure, processing circuitry may be configured to selectively bypass processing with the first pipeline, such as in cases where a first subset of input bits for a current pixel is the same as a first subset of input bits of a previously processed pixel. For instance, two pixels in the frame may have similar pixel values, such as that the bits for the two pixels are almost the same. The most significant bits of the bits for the two pixels may be the same, but there may be a difference in the least significant bits. As an example, in a frame, the color and opacity of two proximate pixels (e.g., neighboring pixels) tends to be same, and the most significant bits of the two proximate pixels may be the same, but there might be slight differences in the least significant bits due to slight changes in color between proximate pixels.

Accordingly, there is high likelihood that when the two pixels are processed, that the resulting output bits for each of the two pixels (e.g., the output bits resulting from the processing of the two pixels) are going to be similar. For instance, the most significant bits of the output bits of the two pixels may be the same, but the least significant bits of the output bits of the two pixels may be different. In one or more examples, if a first subset of input bits of a previously processed pixel is same as a first subset of input bits of a current pixel, then rather than processing the first subset of input bits of the current pixel, a first subset of output bits of the previously processed pixel can be reused as a first subset of output bits of the current pixel.

For instance, the splitter circuit of the processing block may split input bits of a previous pixel into a first subset of input bits of the previous pixel and a second subset of input bits of the previous pixel. The first pipeline of the processing block may process the first subset of input bits of the previous pixel to generate a first subset of output bits of the previous pixel, and the second pipeline of the processing block may process the second subset of input bits of the previous pixel to generate a second subset of output bits of the previous pixel. The merge circuit may merge the first subset of output bits of the previous pixel and the second subset of output bits of the previous pixel to generate the output bits of the previous pixel. In this example, because the previous pixel has been processed, the previous pixel is a previously processed pixel.

The splitter circuit may then receive input bits of a current pixel, and split the input bits of the current pixel into a first subset of input bits of the current pixel and a second subset of input bits of the current pixel. In accordance with one or more examples, processing circuitry of the processing block may determine whether the first subset of input bits of the current pixel is the same as the first subset of input bits of the previously processed pixel. If the first subset of input bits of the current pixel is the same as the first subset of input bits of the previously processed pixel, the processing circuitry may bypass processing the first subset of input bits of the current pixel through the first pipeline, and output the first subset of output bits of the previously processed pixel as the first subset of output bits of the current pixel. If the first subset of input bits of the current pixel is not the same as the first subset of input bits of the previously processed pixel, the processing circuitry may cause the first pipeline to process the first subset of input bits of the current pixel to generate the first subset of output bits of the current pixel.

The second pipeline may be configured to process the second subset of input bits of the current pixel regardless of whether the processing of the first pipeline is bypassed or not to generate a second subset of output bits of the current pixel. However, by selectively bypassing processing with the first pipeline, there may be a reduction in power consumption. The merge circuit may merge the first subset of output bits of the current pixel with the second subset of output bits of the current pixel to generate the output bits of the current pixel.

The above example of a processing block that includes two or more pipelines (e.g., the first and second pipelines) and processing circuitry to selectively bypass processing of a first pipeline is described with respect to camera processor 14 for ease of description. However, the example techniques may be utilized in CPU 16, GPU 18, display processor 26, or one or more other components of camera device 10, such as components configured to process pixels. Accordingly, the example techniques may be for an image processor, and examples of the image processor include camera processor 14, CPU 16, GPU 18, and display processor 26, as a few non-limiting examples. Moreover, because a processing block of the image processor includes two or more pipelines, where each pipeline is configured to process respective subsets of bits of pixel values of pixels, the image processor may be considered as having a split pixel architecture for image processing.

CPU 16 may comprise a general-purpose or a special-purpose processor that controls operation of camera device 10. A user may provide input to camera device 10 to cause CPU 16 to execute one or more software applications. The software applications that execute on CPU 16 may include, for example, a media player application, a video game application, a graphical user interface application or another program. The user may provide input to camera device 10 via one or more input devices (not shown) such as a keyboard, a mouse, a microphone, a touch pad or another input device that is coupled to camera device 10 via user interface 22.

One example of the software application is a camera application. CPU 16 executes the camera application, and in response, the camera application causes CPU 16 to generate content that display 28 outputs. GPU 18 may be configured to process the content generated by CPU 16 for rendering on display 28. For instance, display 28 may output information such as light intensity, whether flash is enabled, and other such information. The user of camera device 10 may interface with display 28 to configure the manner in which the images are generated (e.g., with or without flash, focus settings, exposure settings, and other parameters).

As one example, after executing the camera application, camera device 10 may be considered to be in preview mode. In preview mode, camera 12 outputs image content to camera processor 14 that performs camera processing and outputs image content to system memory 30 that display processor 26 retrieves and outputs on display 28. In preview mode, the user, via display 28, can view the image content that will be captured when the user engages a button (real or on display) to take a picture. As another example, rather than taking a still image (e.g., picture), the user may record video content (e.g., a series of images). During the recording, the user may be able to view the image content being captured on display 28.

Memory controller 24 facilitates the transfer of data going into and out of system memory 30. For example, memory controller 24 may receive memory read and write commands, and service such commands with respect to memory 30 in order to provide memory services for the components in camera device 10. Memory controller 24 is communicatively coupled to system memory 30. Although memory controller 24 is illustrated in the example of camera device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting frames from camera processor 14, etc. System memory 30 may additionally store information for use by and/or generated by other components of camera device 10. For example, system memory 30 may act as a device memory for camera processor 14.

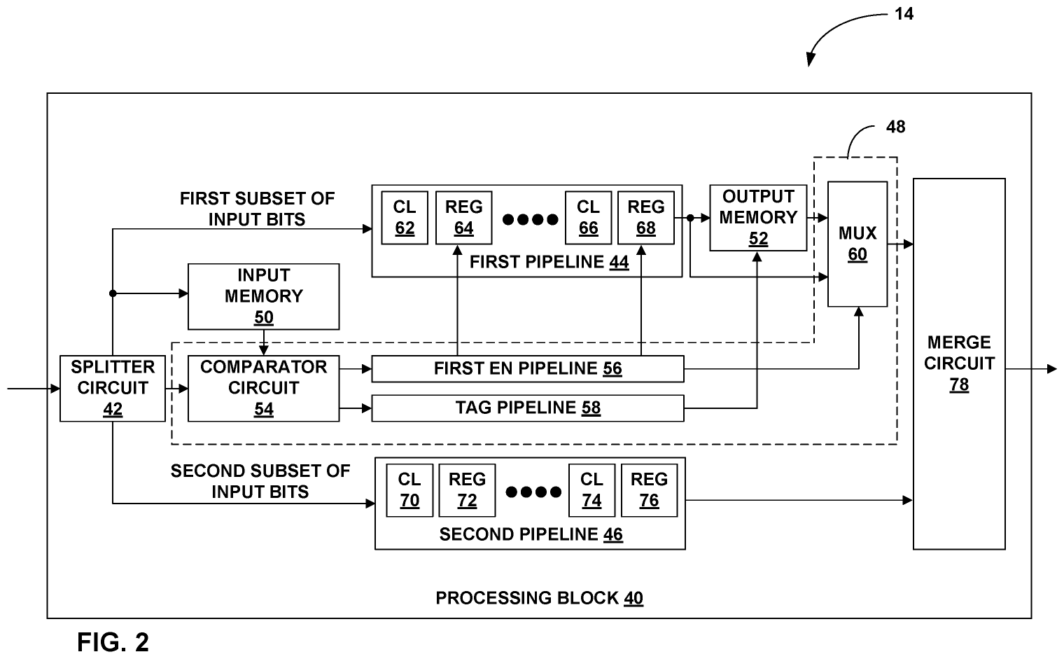

FIG. 2 is a block diagram illustrating a processing block of a camera processor of FIG. 1 in greater detail. For instance, FIG. 2 illustrates processing block 40 of camera processor 14. Although processing block 40 is illustrated as being part of camera processor 14, processing block 40 may be considered as being part of an image processor. Examples of the image processor include camera processor 14, CPU 16, GPU 18, and display processor 26, as a few examples.

Processing block 40 may be configured to process input bits of a pixel and generate output bits of a pixel. Although possible, the input bits of a pixel need not necessarily be the pixel values of a pixel in a frame captured by camera 12. Rather, processing block 40 may be in a series of blocks, and the input bits of a pixel may be bits generated by a previous processing block in the series of blocks. Similarly, although possible, the output bits of the pixel generated with processing block 40 need not necessarily be the final pixel values of a pixel in a frame that is displayed. Rather, the output bits of a pixel may be output bits generated by processing block 40 that feed as input bits of the pixel for a subsequent processing block in the series of processing blocks. Accordingly, in this disclosure, examples of input bits of a pixel should not be considered limited to examples where the input bits are the pixel value of a pixel of frame as captured by camera 12, but may include an intermediate pixel value of the pixel generated by a previous processing block. Examples of the output bits of a pixel should not be considered limited to examples where the output bits are the pixel value of the pixel of the frame as displayed, but may include an intermediate pixel value of the pixel that is output to a subsequent processing block.

As illustrated, processing block 40 includes splitter circuit 42, first pipeline 44, second pipeline 46, selector circuit 48, input memory 50, output memory 52, and merge circuit 78. In some examples, selector circuit 48 and merge circuit 78 may be considered as processing circuitry configured to perform one or more example techniques described in this disclosure. For instance, selector circuit 48 and merge circuit 78 may be formed as fixed-function circuitry, programmable circuitry, or a combination thereof. For ease, the example techniques are described with respect to selector circuit 48 and merge circuit 78, with the understanding that selector circuit 48 and merge circuit 78 may be combined together or formed separately as fixed-function circuitry, software executing on programmable circuitry, or a combination thereof

First pipeline 44 includes combination logic (CL) 62 and 66 and registers 64 and 68. Second pipeline 46 includes CL 70 and 74 and registers 72 and 76. First pipeline 44 and second pipeline 46 may include more or fewer CLs and registers than illustrated in FIG. 2. In some examples, CL 62, 66, 70, and 74 may be fixed-function circuitry such as adders, subtractors, multipliers, and left-shifters, and generally circuitry for linear operation. In some examples, although not required, combination logic used for non-linear operations such as clamp, comparison, or right-shift may not be part of first pipeline 44 or second pipeline 46.

In some cases, the operations of CL 62, 66, 70, and 74 may be fixed. For instance, the operations for filtering, blending, stitching, Bayer transformation, demosaicing, noise reduction, and image sharpening may be the same, but the input values and parameters for performing the operations may be different. For example, filtering may include scaling and addition or subtraction on input values. The scaling parameter and the offset parameter for addition or subtraction may be different in different cases, but the operation of scaling (e.g., multiplying) and adding or subtracting may be the same for filtering. Accordingly, in some examples, CL 62, 66, 70, and 74 may be fixed-function circuitry, where the input values and parameters provided to CL 62, 66, 70, and 74 may be different for different pixels but the operations performed by CL 62, 66, 70, and 74 may be the same. For instance, the operations that CL 62 and CL 66 perform may be different from one another, but CL 62 may be configured to perform the same operations for different input values and parameters, and CL 66 may be configured to perform the same operations for different input values and parameters. Similarly, the operations that CL 70 and CL 74 perform may be different from one another, but CL 70 may be configured to perform the same operations for different input values and parameters, and CL 74 may be configured to perform the same operations for different input values and parameters.

CL 62, 66, 70, and 74 being fixed-function circuitry and each performing operations that are same for different input values is provided as one example and should not be considered limiting. In some examples, CL 62, 66, 70, and 74 may be programmable circuitry, and the operations performed by CL 62, 66, 70, and 74 may be configurable and changeable.

Selector circuit 48 may include comparator circuit 54, first enable pipeline 56, tag pipeline 58, and multiplexer (MUX) 60. As described in more detail, tag pipeline 58 may be optional. For instance, if input memory 50 stores bits for only one previously processed pixel, then tag pipeline 58 may not be needed.

In one or more examples, selector circuit 48 may be configured selectively bypass processing with first pipeline 44, which in turn reduces power consumption of processing block 40. Processing block 40 may be configured to process input bits of a previous pixel and generate output bits of the previous pixel. In some examples, two pixels (e.g., the previous pixel and a current pixel) in the frame may have similar pixel values, and therefore, the input bits received for the current pixel may be similar to the input bits received for the previous pixel.

In some examples, there may be slight differences between the input bits received for the current pixel may be similar to the input bits received for the previous pixel. As one example, a first subset of the input bits of the previous pixel and a first subset of input bits of the current pixel may be the same, but a second subset of the input bits of the previous pixel and a second subset of the input bits of the current pixel may be different. For instance, the first subset may be the most significant bits (MSBs) and the second subset may be the least significant bits (LSBs). For two pixels that are somewhat proximate, the color of the two pixels tends to be similar, and therefore, the MSBs may be the same for the two pixels, but the LSBs can be different.

First pipeline 44 may be configured to selectively process respective first subsets of input bits of pixels to generate respective first subsets of output bits. Second pipeline 44 may be configured to process respective second subsets of input bits of pixels to generate respective second subsets of output bits. For instance, as illustrated, splitter circuit 42 may split input bits received with processing block 40 into a first subset of input bits and a second subset of input bits. First pipeline 44 receives the first subset of input bits for processing through CL 62, register 64, CL 66, and register 68, and second pipeline 44 receives the second subset of input bits for processing through CL 70, register 72, CL 74, and register 76.

In some examples, if the first subset of input bits of a current pixel are the same as a first subset of input bits of a previously process pixel (e.g., previous pixel), then selector circuit 48 may bypass processing of the first subset of input bits with first pipeline 44. Selector circuit 48 may output a first subset of output bits of the previously processed pixel as a first set of output bits of the current pixel based on the determination that the first subset of input bits of the current pixel are the same as the first subset of input bits of the previously processed pixel.

As illustrated, input memory 50 stores respective first subsets of input bits. For instance, input memory 50 may store respective first subsets of input bits of each of N previously processed pixels (e.g., store a first subset of input bits of a previous pixel, stored a first subset of input bits of a pixel previous to the previous pixel, and so forth for N previous pixels). Input memory 50 may be memory with N memory blocks, where each of the memory blocks stores the first subset of input bits for respective previous pixels. When input memory 50 is full and a new pixel comes with first subsets of input bits that are different than the stored first subsets of input bits in input memory 50 of any of previously processed pixels, one entry in input memory 50 may be replaced with the first subset of input bits of the new pixel.

Comparator circuit 54 of selector circuit 48 may receive the first subset of input bits for a current pixel from splitter circuit 42 and may compare the first subset of input bits for the current pixel from splitter circuit 42 with respective first subsets of input bits of the previously processed pixels. Comparator circuit 54 may determine whether a first subset of input bits of the current pixel are same as a first subset of input bits of a previously processed pixel.

If comparator circuit 54 determines that a first subset of input bits of the current pixel are same as a first subset of input bits of a previously processed pixel, comparator circuit 54 may determine a location in input memory 50 (e.g., which block in input memory 50) where the first subset of input bits of the previously processed pixel is stored. The determined location in input memory 50 may be an index used to identify a location (e.g., block) in output memory 52, as described in more detail. Comparator circuit 54 may output the index through tag pipeline 58. In examples, where input memory 50 stores the first subset of input bits for only one previously processed pixel, tag pipeline 58 may not be needed because there is only one location (e.g., block) in which the first subset of input bits of the previously processed pixel is stored.

If comparator circuit 54 determines that a first subset of input bits of the current pixel are same as a first subset of input bits of a previously processed pixel stored in input memory 50, first enable pipeline 56 of selector circuit 48 may be configured to selectively bypass the processing of the first subset of input bits of the current pixel through first pipeline 44. There may be various ways in which first enable pipeline 56 may be configured to bypass processing through first pipeline 44.

As one example, first enable pipeline 56 may output a disable signal to each of registers 64 and 68 to disable registers 64 and 68 from receiving or outputting any values from CL 62 and CL 66, respectively. As another example, first enable pipeline 56 may output a signal that disables a clock signal used to cause register 64 and register 68 to perform respective operations. In both of these examples, the processing through first pipeline 44 may be considered as being bypassed. There may be other ways in which first enable pipeline 56 may bypass processing of the first subset of input bits of the current pixel through first pipeline 44.

If comparator circuit 54 determines that a first subset of input bits of the current pixel are not the same as a first subset of input bits of any of the previously processed pixels stored in input memory 50, then first enable pipeline 56 of selector circuit 48 may cause first pipeline 44 to process the first subset of input bits. For example, first enable pipeline 56 may output an enable signal to each of registers 64 and 68. As another example, first enable pipeline 56 may output a signal that enables the clock signal used to cause registers 64 and 68 to perform respective operations.

Output memory 52 may receive the output from first pipeline 44, which may be a first subset of output bits, and store the first subset of output bits. Output memory 52 may be similar to input memory 50. For example, output memory 52 may store the first subset of output bits of N previously processed pixels that are each identifiable by an index into output memory 52.

As an example, input memory 50 may store a first subset of input bits of a first previously processed pixel in a first location of input memory 50. First pipeline 44 may have previously processed the first previously processed pixel and generated a first subset of output bits of the first previously processed pixel. Output memory 52 may store the first subset of output bits of the first previously processed pixel in a first location of output memory 52. Input memory 50 may store a first subset of input bits of a second previously processed pixel in a second location of input memory 50. First pipeline 44 may have previously processed the second previously processed pixel and generated a first subset of output bits of the second previously processed pixel. Output memory 52 stores the first subset of output bits of the second previously processed pixel in a second location of output memory 52, and so forth until both input memory 50 and output memory 52 are full.

As described above, comparator circuit 54 may determine an index into input memory 50 for the first subset of input bits of the previously processed pixel that was the same as the first subset of input bits of the current pixel. The index into input memory 50 may be the same index into output memory 52. In this way, comparator circuit 54 may determine an index into output memory 52 that stores respective first subsets of output bits of one or more previously processed pixels corresponding to respective first subsets of input bits of one or more previously processed pixels. The index identifies the first subset of output bits of the previously processed pixel in output memory 52.

Tag pipeline 58 may receive the index from comparator circuit 54 that tag pipeline 58 outputs to output memory 52. Output memory 52 may then output the first subset of output bits of the previously processed pixel based on the determined index.

MUX 60 of selector circuit 48 may output a first subset of output bits from output memory 52 or from first pipeline 44. For example, if comparator circuit 54 determined that the first subset of input bits of the current pixel are same as the first subset of input bits of the previously processed pixel, first enable pipeline 56 may cause MUX 60 to output from output memory 52. In this way, selector circuit 48 may be configured to output a first subset of output bits of the previously processed pixel as a first subset of output bits of the current pixel based on the determination that the first subset of input bits of the current pixel are the same as the first subset of input bits of the previously processed pixel. That is, the first subset of output bits of the previously processed pixel are reused as the first subset of output bits of the current pixel.

In the above example, comparator circuit 54 determined that the first subset of input bits of the current pixel are same as the first subset of input bits of the previously processed pixel. However, in some examples, comparator circuit 54 may determine that a first subset of input bits of a subsequent pixel (e.g., a pixel other than current pixel) is not the same as a first subset of input bits of previously processed pixels (e.g., the first subset of input bits of the subsequent pixel is different than any of the subsets of input bits stored in input memory 50). In such examples, first enable pipeline 56 may cause first pipeline 44 to process the first subset of input bits for the subsequent pixel to generate a first subset of output bits of the subsequent pixel. First enable pipeline 56 may cause MUX 60 to output from first pipeline 44.

First enable pipeline 56 and tag pipeline 58 may each include a plurality of flip-flops for timing purposes. For instance, second pipeline 46 may be configured to process the second subset of input bits. In some examples, second pipeline 46 may be configured to process the second subset of input bits regardless of whether processing through first pipeline 44 is bypassed or not. Processing through second pipeline 46 may utilize multiple clock cycles. To ensure proper timing so that MUX 60 and second pipeline 46 output to merge circuit 78 at substantially the same time, first enable pipeline 46 and tag pipeline 58 may include a plurality of flip-flops that control when output memory 52 and MUX 60 output to merge circuit 78 to substantially synchronize the output from MUX 60 with second pipeline 46.

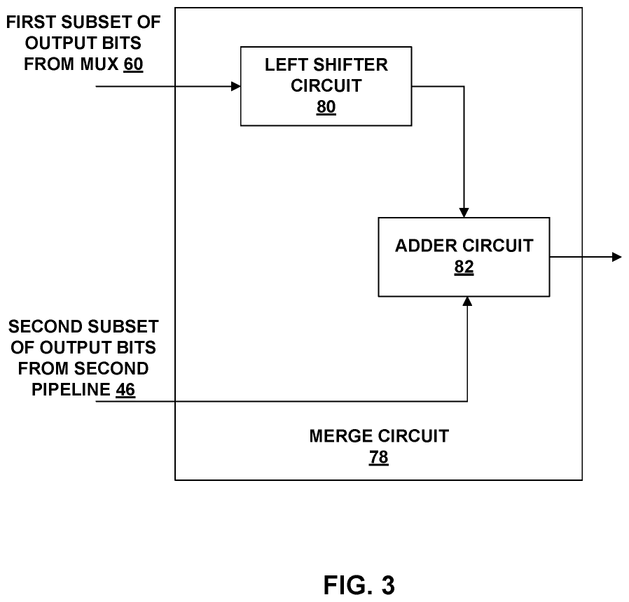

Merge circuit 78 may be configured to merge the first subset of output bits of the current pixel, as outputted by MUX 60, with a second subset of output bits as generated through second pipeline 46 from a second subset of input bits of the current pixel. As example of merge circuit 78 is illustrated in FIG. 3.

Accordingly, FIG. 2 illustrates an example with first pipeline 44 configured to selectively process respective first subsets of input bits of pixels to generate respective first subsets of output bits, and second pipeline 46 configured to process respective second subsets of the input bits of the pixels to generate respective second subsets of output bits. Splitter circuit 42 may be configured to split input bits of a current pixel into a first subset of input bits of the current pixel and a second subset of input bits of the current pixel. First pipeline 44 may receive the first subset of input bits for selectively processing, and second pipeline 46 may receive the second subset of input bits for processing.

Selector circuit 48 may be configured to determine that a first subset of input bits of a current pixel are same as a first subset of input bits of a previously processed pixel. In some examples, the previously processed pixel may be a previously processed pixel that is proximate to the current pixel. As one example, the previously processed pixel is a previously processed pixel that neighbors the current pixel.

For example, comparator circuit 54 of selector circuit 48 may access input memory 50 that stores respective first subsets of input bits of one or more previously processed pixels, compare the first subset of input bits of the current pixel to the respective first subsets of input bits of one or more previously processed pixels, and determine the previously processed pixel having the same first subset of input bits as the first subset of input bits of the current pixel based on the comparison.

Selector circuit 48 may selectively bypass processing the first subset of input bits of the current pixel through first pipeline 44 based on the determination that the first subset of input bits of the current pixel are the same as the first subset of input bits of the previously processed pixel. For example, first enable pipeline 56 of selector circuit 48 may be configured to output a disable signal to registers 64 and 68, as one way to selectively bypass processing the first subset of input bits of the current pixel through first pipeline 44. As another example, first enable pipeline 56 may be configured to output a signal that disables first pipeline 44 from receiving a clock signal used for the operation of registers 64 and 68.

In some examples, selector circuit 48 may output a first subset of output bits of the previously processed pixel as a first subset of output bits of the current pixel based on the determination that the first subset of input bits of the current pixel are the same as the first subset of input bits of the previously processed pixel. For example, MUX 60 of selector circuit 48 may receive a signal from first enable pipeline 56 that indicates whether MUX 60 is to output from output memory 52 or first pipeline 44. Based on the determination that the first subset of input bits of the current pixel are the same as the first subset of input bits of the previously processed pixel, first enable pipeline 56 may output a signal that causes MUX 60 to output from output memory 52.

Because output memory 52 stores respective first subsets of output bits of one or more previously processed pixels, when MUX 60 outputs from output memory 52, MUX 60 may be considered as outputting a first subset of output bits of the previously processed pixel as a first subset of output bits of the current pixel (e.g., the first subset of output bits of the previously processed pixel is reused as the first subset of output bits of the current pixel). As one example, comparator circuit 54 may determine an index into output memory 52 that stores respective first subsets of output bits of one or more previously processed pixels corresponding to respective first subsets of input bits of the one or more previously processed pixels. The index identifies the first subset of output bits of the previously processed pixel in output memory 52.

For example, comparator circuit 54 may determine the location in input memory 50 for where the first subset of input bits of the previously processed pixel, having the same bits as the first subset of input bits of the current pixel, are stored. The location may be an index in output memory 52 that tag pipeline 58 outputs to output memory 52, and output memory 52 outputs the first subset of output bits of the previously processed pixel based on the determined index in output memory 52.

Merge circuit 78 may be configured to merge the first subset of output bits of the current pixel with a second subset of output bits of the current pixel generated through the second pipeline from a second subset of input bits of the current pixel. For example, second pipeline 46 may process the second subset of input bits of the current pixel regardless of whether processing through first pipeline 44 is bypassed or not. Merge circuit 78 may then combine the first subset of output bits and the second subset of output bits to generate the output bits that processing block 40 outputs, possibly to a subsequent processing block.

In the above example, the first subset of input bits of the current pixel may be the most significant bits (MSBs) of the input bits. The second subset of input bits of the current pixel may be the least significant bits (LSBs) of the input bits. The first subset of output bits of the current pixel may be the MSBs of the output bits. The second subset of output bits may be LSBs of the output bits. As an example, the input bits of the current pixel equal 16 input bits, the output bits of the current pixel equal 16 output bits, the first subset of input bits equals 5 most significant bits (MSBs) of the 16 input bits, the second subset of input bits equals 11 least significant bits (LSBs) of the 16 input bits, the first subset of output bits equals 5 MSBs of the 16 output bits, and the second subset of output bits equals 11 LSBs of the 16 output bits.

In the above example, first pipeline 44 is selectively bypassed based on the first subset of input bits being the same as the first subset of input bits of the previously processed pixel. However, there may be other instances where processing through first pipeline 44 is selectively bypassed.

As one example, camera 12 may include a sensor that generates 16 bits per pixel (e.g., 16 BPP). In some examples, camera device 10 may include additional cameras. For instance, another camera of camera device 10 may include a sensor that generates 10 bits per pixel (e.g., 10 BPP), such as for a depth sensor. In some examples, it may be possible for second pipeline 46 to process all of the bits from the other camera without needing first pipeline 44 to process any of bits from the other camera, and first pipeline 44 can be turned off.

For example, a number of bits of input bits of a pixel from the depth sensor may be less than or equal to a number of bits that are processed through second pipeline 46. For instance, the number of bits of input bits of the pixel from the depth sensor may be 10 bits, and second processing pipeline 46 may be configured to process 11 bits. In such examples, selector circuit 48 may be configured to bypass processing any of the input bits of the pixel from the depth sensor through first pipeline 44, and second pipeline 46 may be configured to process all of the input bits of the subsequent pixel.

As described above, selector circuit 48 may selectively bypass processing the first subset of input bits of the current pixel through first pipeline 44 based on the determination that the first subset of input bits of the current pixel are the same as the first subset of input bits of the previously processed pixel. However, in some examples, for a subsequent pixel (e.g., pixel other a current pixel), the first subset of input bits of the subsequent pixel may not be the same as a first subset of input bits of previously processed pixels stored in input memory 50.

In such examples, first processing pipeline 44 may be configured to process a first subset of input bits of a subsequent pixel to generate a first subset of output bits of the subsequent pixel based on the first subset of input bits of the subsequent pixel not being the same as a first subset of input bits of previously processed pixels. Second processing pipeline 46 may be configured to process a second subset of input bits of the subsequent pixel to generate a second subset of output bits of the subsequent pixel. Merge circuit 78 may be configured to merge the first subset of output bits of the subsequent pixel with the second subset of output bits of the subsequent pixel.

FIG. 3 is a block diagram illustrating a merge circuit of the processing block of FIG. 2 in greater detail. As illustrated, merge circuit 78 includes left shifter circuit 80 and adder circuit 82. Left shifter circuit 80 may receive the first subset of output bits from MUX 60 and may be configured to left shift the first subset of output bits by the number of bits that second pipeline 46 is configured to process. For example, if second pipeline 46 is configured to process 11 bits, then left shifter circuit 80 may left shift the first subset of output bits from MUX 60 by 11 bits.

Adder circuit 82 may receive the second subset of output bits from second pipeline 46, and add the output from left shifter circuit 80 with the second subset of output bits to generate the output bits for processing block 40. As an example, assume that the first subset of output bits is 10111, and assume that the second subset of output bits is 01010101011. In this example, left shifter circuit 80 may left shift the first subset of output bits to generate 1011100000000000. Adder circuit 82 may add the output from left shifter circuit 80 with second subset of output bits from second pipeline 46 to generate 1011101010101011.

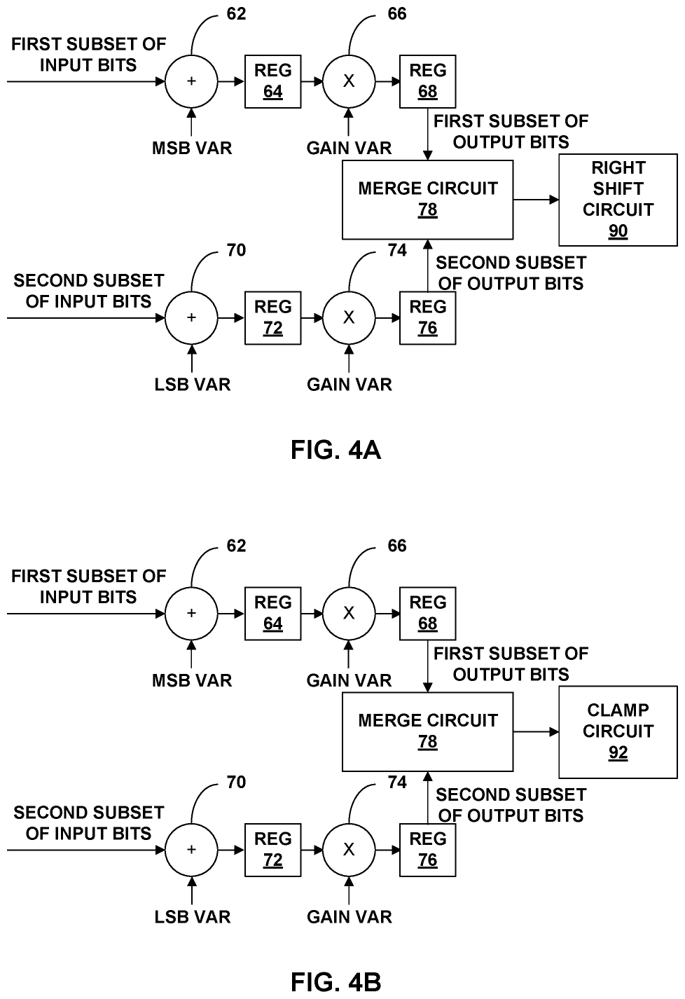

FIGS. 4A and 4B are conceptual diagram illustrating examples of a first pipeline and a second pipeline for pixel processing in accordance with one or more examples described in this disclosure. As described above, CL 62, 66, 70, and 74 may be configured to perform linear operators. For instance, FIGS. 4A and 4B illustrates an example where CL 62 and CL 70 are adders and CL 66 and CL 74 are multipliers.

However, because processing block 40 is split into two or more processing pipelines each configured to process a subset of bits (e.g., MSBs and LSBs), depending on the operation that CL 62, 66, 70, and 74 need to perform, the parameters on which CL 62, 66, 70, and 74 operate may be divided into subsets (e.g., MSBs and LSBs). For instance, as illustrated in FIGS. 4A and 4B, to add the value “VAR,” (e.g., variable) the value of VAR may be divided into an MSB portion (“MSB VAR”) and an LSB portion (“LSB VAR”). In FIGS. 4A and 4B, CL 62 may add MSB VAR to the first subset of input bits, and CL 70 may add LSB VAR to the second subset of input bits.

For operations like multiplication, due to the distributive property of multiplication, there may not be a need to split a value being multiplied into MSB portion and LSB portion. For instance, in FIGS. 4A and 4B, CL 66 and 74 may each be configured to multiply the GAIN VAR without dividing GAIN VAR into MSB portion and LSB portion.

However, for division operations and non-linear operations, merge circuit 78 may first merge the first subset of output bits and the second subset of output bits, and then the operation may be performed. For instance, in FIG. 4A, merge circuit 78 may merge the first subset of output bits and the second subset of output bits, and then right shift circuit 90 may perform the right shift operation (e.g., division). In FIG. 4B, merge circuit 78 may merge the first subset of output bits and the second subset of output bits, and then clamp circuit 92 may perform the clamping operation.

The number of CLs that can be included in first pipeline 44 and second pipeline 46 may be based on the number of linear operations that can be performed before non-linear operations are needed. In some examples, to maximize power savings, there may be benefits in increasing the number of CLs that perform linear operations that can be included in first pipeline 44 and second pipeline 46.

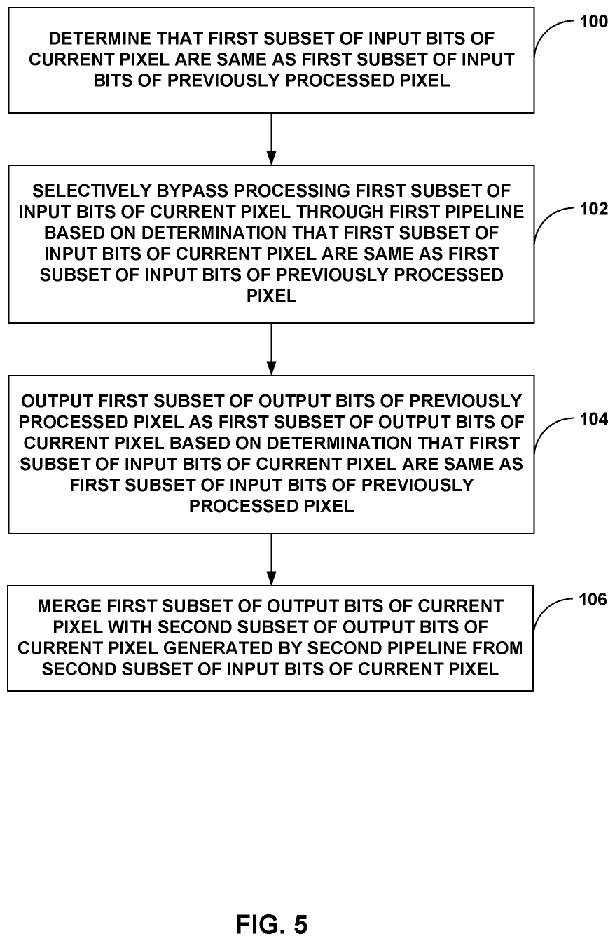

FIG. 5 is a flowchart illustrating an example method of operation in accordance with one or more examples described in this disclosure. The example of FIG. 5 may be performed with an image processor. Examples of the image processor include one or any combination of camera processor 14, CPU 16, GPU 18, and display processor 26.

The example of FIG. 5 is described with respect to selector circuit 48 and merge circuit 78. Selector circuit 48 and merge circuit 78 may be formed together or separately. Selector circuit 48 and merge circuit 78 are examples of fixed-function circuitry, programmable circuitry, or a combination thereof. For instance, the example techniques of FIG. 5 may be considered as being performed by processing circuitry. In some examples, splitter circuit 42 may also be considered as processing circuitry that is separate or combined with selector circuit 48 and merge circuit 78. In some examples, first pipeline 44 and second pipeline 46 may also be programmable, and part of or separate from the processing circuitry that includes one or more of splitter circuit 42, selector circuit 48, and merge circuit 78.

Selector circuit 48 may be configured to determine that a first subset of input bits of a current pixel are same as a first subset of input bits of a previously processed pixel (100). For example, comparator circuit 54 may access input memory 50 that stores respective first subsets of input bits of one or more previously processed pixels, compare the first subset of input bits of the current pixel to the respective first subsets of input bits of one or more previously processed pixels, and determine the previously processed pixel having the same first subset of input bits as the first subset of input bits of the current pixel based on the comparison. As one example, the previously processed pixel is a previously processed pixel that neighbors the current pixel.

Selector circuit 48 may selectively bypass processing the first subset of input bits of the current pixel through first pipeline 44 based on the determination that the first subset of input bits of the current pixel are the same as the first subset of input bits of the previously processed pixel (102). First pipeline 44 is configured to selectively process respective first subsets of input bits of pixels to generate respective first subsets of output bits. As one example, first enable pipeline 56 may output signals that disable registers 64 and 68 or disable CL 62 and 66 from receiving a clock signal used by CL 62 and CL 66 for performing operations.

Selector circuit 48 may output a first subset of output bits of the previously processed pixel as a first subset of output bits of the current pixel based on the determination that the first subset of input bits of the current pixel are the same as the first subset of input bits of the previously processed pixel (104). Second pipeline 46 is configured to process respective second subsets of the input bits of the pixels to generate respective second subsets of output bits. For example, MUX 60 may output from output memory 52 or first pipeline 44. For instance, comparator circuit 54 may determine an index into output memory 52 that stores respective first subsets of output bits of one or more previously processed pixels corresponding to respective first subsets of input bits of the one or more previously processed pixels. The index identifies the first subset of output bits of the previously processed pixel in output memory 52. Output memory 52 may output to MUX 60 the first subset of output bits of the previously processed pixel based on the determined index.

In some examples, the first subset of input bits of the current pixel may be most significant bits (MSBs) of the input bits, the second subset of input bits of the current pixel may be the least significant bits (LSBs) of the input bits, the first subset of output bits of the current pixel may be MSBs of the output bits, and the second subset of output bits may be LSBs of the output bits. In some examples, the input bits of the current pixel equal 16 input bits, the output bits of the current pixel equal 16 output bits, the first subset of input bits equals 5 MSBs of the 16 input bits, the second subset of input bits equals 11 LSBs of the 16 input bits, the first subset of output bits equals 5 MSBs of the 16 output bits, and the second subset of output bits equals 11 LSBs of the 16 output bits.

Merge circuit 78 may be configured to merge the first subset of output bits of the current pixel with a second subset of output bits of the current pixel generated through second pipeline 46 from a second subset of input bits of the current pixel (106). For example, second pipeline 46 may be configured to process the second subset of input bits regardless of whether processing through first pipeline 44 is processed or not to generate the second subset of output bits. Merge circuit 78 may include left shifter circuit 80 and adder circuit 82 to merge the first subset of output bits and the second subset of output bits.

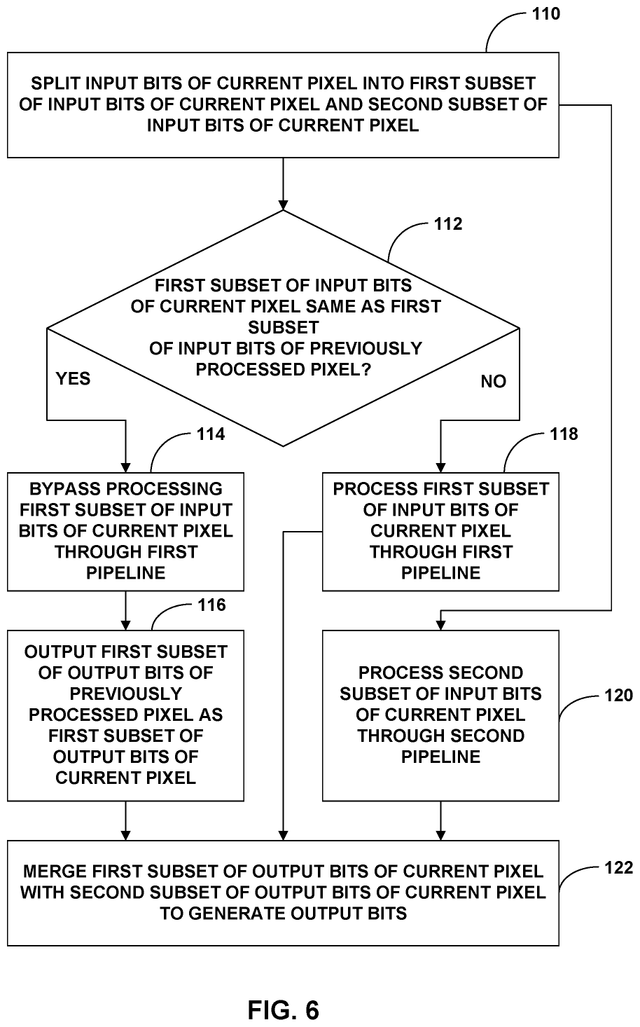

FIG. 6 is a flowchart illustrating another example method of operation in accordance with one or more examples described in this disclosure. In the example of FIG. 6, splitter circuit 42 may split input bits (e.g., 16 bits) of a current pixel into a first subset of input bits (e.g., 5 bits) of the current pixel and a second subset of input bits (e.g., 11 bits) of the current pixel (110).

Comparator circuit 54 may determine whether the first subset of input bits of the current pixel are the same as a first subset of input bits of a previously processed pixel (112). For instance, comparator circuit 54 may compare the first subset of input bits of the current pixel to respective subsets of input bits of previously processed pixels stored in input memory 50.

If comparator circuit 54 determined that the first subset of input bits of the current pixel are the same as the first subset of input bits of the previously processed pixel (YES of 112), then first enable pipeline 56 may bypass processing of the first subset of input bits of the current pixel through first pipeline 44 (114), and may cause MUX 60 to output a first subset of output bits of the previously processed pixel as the first subset of output bits of the current pixel (116). If comparator circuit 54 determined that the first subset of input bits of the current pixel are not the same as the first subset of input bits of the previously processed pixel (NO of 112), then first pipeline 44 may process the first subset of input bits of the current pixel through first pipeline 44 (118). Regardless of whether processing through first pipeline 44 is bypass or not, second pipeline 46 may be configured to process a second subset of input bits of the current pixel through second pipeline 46 (120).

Merge circuit 78 may be configured to merge the first subset of output bits of the current pixel with the second subset of output bits of the current pixel to generate output bits (122). The first subset of output bits of the current pixel may be the first subset of output bits of the previously processed pixel or the output from first pipeline 44 based on whether the first subset of input bits of the current pixel are the same as a first subset of input bits of a previously processed pixel.

The following describes examples of clauses of techniques. The techniques of the clauses may be used separately or in any combination.

Clause 1: An image processor for processing pixels includes a first pipeline configured to selectively process respective first subsets of input bits of pixels to generate respective first subsets of output bits; a second pipeline configured to process respective second subsets of the input bits of the pixels to generate respective second subsets of output bits; and processing circuitry configured to: determine that a first subset of input bits of a current pixel are the same as a first subset of input bits of a previously processed pixel; selectively bypass processing the first subset of input bits of the current pixel through the first pipeline based on the determination that the first subset of input bits of the current pixel are the same as the first subset of input bits of the previously processed pixel; output a first subset of output bits of the previously processed pixel as a first subset of output bits of the current pixel based on the determination that the first subset of input bits of the current pixel are the same as the first subset of input bits of the previously processed pixel; and merge the first subset of output bits of the current pixel with a second subset of output bits of the current pixel generated through the second pipeline from a second subset of input bits of the current pixel.

Clause 2: The image processor of clause 1, wherein the processing circuitry comprises a selector circuit and a merge circuit, wherein the selector circuit is configured to: determine that the first subset of input bits of a current pixel are same as the first subset of input bits of a previously processed pixel; selectively bypass processing the first subset of input bits of the current pixel through the first pipeline based on the determination that the first subset of input bits of the current pixel are the same as the first subset of input bits of the previously processed pixel; and output the first subset of output bits of the previously processed pixel as the first subset of output bits of the current pixel based on the determination that the first subset of input bits of the current pixel are the same as the first subset of input bits of the previously processed pixel, and wherein the merge circuit is configured to: merge the first subset of output bits of the current pixel with the second subset of output bits of the current pixel generated through the second pipeline from the second subset of input bits of the current pixel.

Clause 3: The image processor of any of clauses 1 and 2, wherein the first subset of input bits of the current pixel comprise most significant bits (MSBs) of the input bits, wherein the second subset of input bits of the current pixel comprise least significant bits (LSBs) of the input bits, wherein the first subset of output bits of the current pixel comprise MSBs of the output bits, and wherein the second subset of output bits comprise LSBs of the output bits.

Clause 4: The image processor of any of clauses 1 through 3, wherein: the first processing pipeline is configured to process a first subset of input bits of a subsequent pixel to generate a first subset of output bits of the subsequent pixel based on the first subset of input bits of the subsequent pixel not being the same as a first subset of input bits of previously processed pixels, the second processing pipeline is configured to process a second subset of input bits of the subsequent pixel to generate a second subset of output bits of the subsequent pixel based on the first subset of input bits of the subsequent pixel not being the same as a first subset of input bits of previously processed pixels, and the processing circuitry is configured to merge the first subset of output bits of the subsequent pixel with the seconds subset of output bits of the subsequent pixel.

Clause 5: The image processor of any of clauses 1 through 4, wherein the processing circuitry is configured to: split the input bits of the current pixel into the first subset of input bits of the current pixel and the second subset of input bits of the current pixel.

Clause 6: The image processor of clause 5, wherein the processing circuitry is configured to: receive input bits of a subsequent pixel, wherein a number of bits of the input bits of the subsequent pixel is less than or equal to a number of bits that are processed through the second pipeline, and bypass processing any of the input bits of the subsequent pixel through the first pipeline, and wherein the second pipeline is configured to process all of the input bits of the subsequent pixel.

Clause 7: The image processor of any of clauses 1 through 6, wherein the previously processed pixel is a previously processed pixel that neighbors the current pixel.

Clause 8: The image processor of any of clauses 1 through 7, wherein determining that the first subset of input bits of the current pixel are same as the first subset of input bits of the previously processed pixel comprises: accessing memory that stores respective first subsets of input bits of one or more previously processed pixels; comparing the first subset of input bits of the current pixel to the respective first subsets of input bits of one or more previously processed pixels; and determining the previously processed pixel having the same first subset of input bits as the first subset of input bits of the current pixel based on the comparison.

Clause 9: The image processor of any of clauses 1 through 8, wherein outputting the first subset of output bits of the previously processed pixel comprises: determining an index into a memory that stores respective first subsets of output bits of one or more previously processed pixels corresponding to respective first subsets of input bits of the one or more previously processed pixels, wherein the index identifies the first subset of output bits of the previously processed pixel in the memory; and outputting the first subset of output bits of the previously processed pixel based on the determined index.

Clause 10: The image processor of any of clauses 1 through 9, wherein the image processor comprises one of a camera processor, a graphics processing unit (GPU), a display processor, or a central processing unit (CPU).

Clause 11: A method of processing pixels includes determining that a first subset of input bits of a current pixel are same as a first subset of input bits of a previously processed pixel; selectively bypassing processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits; outputting a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and merging the first subset of output bits of the current pixel with a second subset of output bits of the current pixel generated through the second pipeline from a second subset of input bits of the current pixel.

Clause 12: The method of clause 11, wherein the first subset of input bits of the current pixel comprise most significant bits (MSBs) of the input bits, wherein the second subset of input bits of the current pixel comprise least significant bits (LSBs) of the input bits, wherein the first subset of output bits of the current pixel comprise MSBs of the output bits, and wherein the second subset of output bits comprise LSBs of the output bits.

Clause 13: The method of any of clauses 11 and 12, further comprising processing, with the first processing pipeline, a first subset of input bits of a subsequent pixel to generate a first subset of output bits of the subsequent pixel based on the first subset of input bits of the subsequent pixel not being the same as a first subset of input bits of previously processed pixels, processing, with the second processing pipeline, a second subset of input bits of the subsequent pixel to generate a second subset of output bits of the subsequent pixel based on the first subset of input bits of the subsequent pixel not being the same as a first subset of input bits of previously processed pixels, and merging the first subset of output bits of the subsequent pixel with the seconds subset of output bits of the subsequent pixel.

Clause 14: The method of any of clauses 11 through 13, further includes splitting the input bits of the current pixel into the first subset of input bits of the current pixel and the second subset of input bits of the current pixel.

Clause 15: The method of any of clauses 11 through 14, further includes receiving input bits of a subsequent pixel, wherein a number of bits of the input bits of the subsequent pixel is less than or equal to a number of bits that are processed through the second pipeline; bypass processing any of the input bits of the subsequent pixel through the first pipeline; and processing, with the second pipeline, all of the input bits of the subsequent pixel.

Clause 16: The method of any of clauses 11 through 15, wherein the previously processed pixel is a previously processed pixel that neighbors the current pixel.

Clause 17: The method of any of clauses 11 through 16, wherein determining that the first subset of input bits of the current pixel are same as the first subset of input bits of the previously processed pixel comprises: accessing memory that stores respective first subsets of input bits of one or more previously processed pixels; comparing the first subset of input bits of the current pixel to the respective first subsets of input bits of one or more previously processed pixels; and determining the previously processed pixel having the same first subset of input bits as the first subset of input bits of the current pixel based on the comparison.

Clause 18: The method of any of clauses 11 through 17, wherein outputting the first subset of output bits of the previously processed pixel comprises: determining an index into a memory that stores respective first subsets of output bits of one or more previously processed pixels corresponding to respective first subsets of input bits of the one or more previously processed pixels, wherein the index identifies the first subset of output bits of the previously processed pixel in the memory; and outputting the first subset of output bits of the previously processed pixel based on the determined index.

Clause 19: The method of any of clauses 11 through 18, wherein an image processor includes the first pipeline and the second pipeline, and wherein the image processor comprises one of a camera processor, a graphics processing unit (GPU), a display processor, or a central processing unit (CPU).

Clause 20: A device for processing pixels includes means for determining that a first subset of input bits of a current pixel are same as a first subset of input bits of a previously processed pixel; means for selectively bypassing processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits; means for outputting a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and means for merging the first subset of output bits of the current pixel with a second subset of output bits of the current pixel generated through the second pipeline from a second subset of input bits of the current pixel.

Clause 21: The device of clause 20, wherein the first subset of input bits of the current pixel comprise most significant bits (MSBs) of the input bits, wherein the second subset of input bits of the current pixel comprise least significant bits (LSBs) of the input bits, wherein the first subset of output bits of the current pixel comprise MSBs of the output bits, and wherein the second subset of output bits comprise LSBs of the output bits.

Clause 22: The device of any of clauses 20 and 21, further includes means for splitting the input bits of the current pixel into the first subset of input bits of the current pixel and the second subset of input bits of the current pixel.

Clause 23: The device of any of clauses 20 through 22, wherein the previously processed pixel is a previously processed pixel that neighbors the current pixel.

Clause 24: The device of any of clauses 20 through 23, wherein the means for determining that the first subset of input bits of the current pixel are same as the first subset of input bits of the previously processed pixel comprises: means for accessing memory that stores respective first subsets of input bits of one or more previously processed pixels; means for comparing the first subset of input bits of the current pixel to the respective first subsets of input bits of one or more previously processed pixels; and means for determining the previously processed pixel having the same first subset of input bits as the first subset of input bits of the current pixel based on the comparison.

Clause 25: The device of any of clauses 20 through 24, wherein the means for outputting the first subset of output bits of the previously processed pixel comprises: means for determining an index into a memory that stores respective first subsets of output bits of one or more previously processed pixels corresponding to respective first subsets of input bits of the one or more previously processed pixels, wherein the index identifies the first subset of output bits of the previously processed pixel in the memory; and means for outputting the first subset of output bits of the previously processed pixel based on the determined index.

Clause 26: A computer-readable storage medium storing instructions thereon that when executed cause one or more processors to: determine that a first subset of input bits of a current pixel are same as a first subset of input bits of a previously processed pixel; selectively bypass processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits; output a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and merge the first subset of output bits of the current pixel with a second subset of output bits of the current pixel generated through the second pipeline from a second subset of input bits of the current pixel.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An image processor for processing pixels comprising:
a first pipeline configured to selectively process respective first subsets of input bits of pixels to generate respective first subsets of output bits;
a second pipeline configured to process respective second subsets of the input bits of the pixels to generate respective second subsets of output bits; and
processing circuitry configured to:
determine that a first subset of input bits of a current pixel are the same as a first subset of input bits of a previously processed pixel;
selectively bypass processing the first subset of input bits of the current pixel through the first pipeline based on the determination that the first subset of input bits of the current pixel are the same as the first subset of input bits of the previously processed pixel;
output a first subset of output bits of the previously processed pixel as a first subset of output bits of the current pixel based on the determination that the first subset of input bits of the current pixel are the same as the first subset of input bits of the previously processed pixel; and
merge the first subset of output bits of the current pixel with a second subset of output bits of the current pixel generated through the second pipeline from a second subset of input bits of the current pixel.

2. The image processor of claim 1,
wherein the processing circuitry comprises a selector circuit and a merge circuit,
wherein the selector circuit is configured to:
determine that the first subset of input bits of a current pixel are same as the first subset of input bits of a previously processed pixel;
selectively bypass processing the first subset of input bits of the current pixel through the first pipeline based on the determination that the first subset of input bits of the current pixel are the same as the first subset of input bits of the previously processed pixel; and
output the first subset of output bits of the previously processed pixel as the first subset of output bits of the current pixel based on the determination that the first subset of input bits of the current pixel are the same as the first subset of input bits of the previously processed pixel, and
wherein the merge circuit is configured to:
merge the first subset of output bits of the current pixel with the second subset of output bits of the current pixel generated through the second pipeline from the second subset of input bits of the current pixel.

3. The image processor of claim 1, wherein the first subset of input bits of the current pixel comprise most significant bits (MSBs) of the input bits, wherein the second subset of input bits of the current pixel comprise least significant bits (LSBs) of the input bits, wherein the first subset of output bits of the current pixel comprise MSBs of the output bits, and wherein the second subset of output bits comprise LSBs of the output bits.

4. The image processor of claim 1, wherein:
the first processing pipeline is configured to process a first subset of input bits of a subsequent pixel to generate a first subset of output bits of the subsequent pixel based on the first subset of input bits of the subsequent pixel not being the same as a first subset of input bits of previously processed pixels,
the second processing pipeline is configured to process a second subset of input bits of the subsequent pixel to generate a second subset of output bits of the subsequent pixel based on the first subset of input bits of the subsequent pixel not being the same as a first subset of input bits of previously processed pixels, and
the processing circuitry is configured to merge the first subset of output bits of the subsequent pixel with the seconds subset of output bits of the subsequent pixel.

5. The image processor of claim 1, wherein the processing circuitry is configured to:
split the input bits of the current pixel into the first subset of input bits of the current pixel and the second subset of input bits of the current pixel.

6. The image processor of claim 5, wherein the processing circuitry is configured to:
receive input bits of a subsequent pixel, wherein a number of bits of the input bits of the subsequent pixel is less than or equal to a number of bits that are processed through the second pipeline, and
bypass processing any of the input bits of the subsequent pixel through the first pipeline, and
wherein the second pipeline is configured to process all of the input bits of the subsequent pixel.

7. The image processor of claim 1, wherein the previously processed pixel is a previously processed pixel that neighbors the current pixel.

8. The image processor of claim 1, wherein determining that the first subset of input bits of the current pixel are same as the first subset of input bits of the previously processed pixel comprises:
accessing memory that stores respective first subsets of input bits of one or more previously processed pixels;
comparing the first subset of input bits of the current pixel to the respective first subsets of input bits of one or more previously processed pixels; and
determining the previously processed pixel having the same first subset of input bits as the first subset of input bits of the current pixel based on the comparison.

9. The image processor of claim 1, wherein outputting the first subset of output bits of the previously processed pixel comprises:
determining an index into a memory that stores respective first subsets of output bits of one or more previously processed pixels corresponding to respective first subsets of input bits of the one or more previously processed pixels, wherein the index identifies the first subset of output bits of the previously processed pixel in the memory; and
outputting the first subset of output bits of the previously processed pixel based on the determined index.

10. The image processor of claim 1, wherein the image processor comprises one of a camera processor, a graphics processing unit (GPU), a display processor, or a central processing unit (CPU).

11. A method of processing pixels comprising:
determining that a first subset of input bits of a current pixel are same as a first subset of input bits of a previously processed pixel;
selectively bypassing processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits;
outputting a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and
merging the first subset of output bits of the current pixel with a second subset of output bits of the current pixel generated through the second pipeline from a second subset of input bits of the current pixel.

12. The method of claim 11, wherein the first subset of input bits of the current pixel comprise most significant bits (MSBs) of the input bits, wherein the second subset of input bits of the current pixel comprise least significant bits (LSBs) of the input bits, wherein the first subset of output bits of the current pixel comprise MSBs of the output bits, and wherein the second subset of output bits comprise LSBs of the output bits.

13. The method of claim 11, further comprising
processing, with the first processing pipeline, a first subset of input bits of a subsequent pixel to generate a first subset of output bits of the subsequent pixel based on the first subset of input bits of the subsequent pixel not being the same as a first subset of input bits of previously processed pixels,
processing, with the second processing pipeline, a second subset of input bits of the subsequent pixel to generate a second subset of output bits of the subsequent pixel based on the first subset of input bits of the subsequent pixel not being the same as a first subset of input bits of previously processed pixels, and
merging the first subset of output bits of the subsequent pixel with the seconds subset of output bits of the subsequent pixel.

14. The method of claim 11, further comprising:
splitting the input bits of the current pixel into the first subset of input bits of the current pixel and the second subset of input bits of the current pixel.

15. The method of claim 11, further comprising:
receiving input bits of a subsequent pixel, wherein a number of bits of the input bits of the subsequent pixel is less than or equal to a number of bits that are processed through the second pipeline;
bypass processing any of the input bits of the subsequent pixel through the first pipeline; and
processing, with the second pipeline, all of the input bits of the subsequent pixel.

16. The method of claim 11, wherein the previously processed pixel is a previously processed pixel that neighbors the current pixel.

17. The method of claim 11, wherein determining that the first subset of input bits of the current pixel are same as the first subset of input bits of the previously processed pixel comprises:
accessing memory that stores respective first subsets of input bits of one or more previously processed pixels;
comparing the first subset of input bits of the current pixel to the respective first subsets of input bits of one or more previously processed pixels; and
determining the previously processed pixel having the same first subset of input bits as the first subset of input bits of the current pixel based on the comparison.

18. The method of claim 11, wherein outputting the first subset of output bits of the previously processed pixel comprises:
determining an index into a memory that stores respective first subsets of output bits of one or more previously processed pixels corresponding to respective first subsets of input bits of the one or more previously processed pixels, wherein the index identifies the first subset of output bits of the previously processed pixel in the memory; and
outputting the first subset of output bits of the previously processed pixel based on the determined index.

19. The method of claim 11, wherein an image processor includes the first pipeline and the second pipeline, and wherein the image processor comprises one of a camera processor, a graphics processing unit (GPU), a display processor, or a central processing unit (CPU).

20. A device for processing pixels comprising:
means for determining that a first subset of input bits of a current pixel are same as a first subset of input bits of a previously processed pixel;
means for selectively bypassing processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits;
means for outputting a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and
means for merging the first subset of output bits of the current pixel with a second subset of output bits of the current pixel generated through the second pipeline from a second subset of input bits of the current pixel.

21. The device of claim 20, wherein the first subset of input bits of the current pixel comprise most significant bits (MSBs) of the input bits, wherein the second subset of input bits of the current pixel comprise least significant bits (LSBs) of the input bits, wherein the first subset of output bits of the current pixel comprise MSBs of the output bits, and wherein the second subset of output bits comprise LSBs of the output bits.

22. The device of claim 20, further comprising:
means for splitting the input bits of the current pixel into the first subset of input bits of the current pixel and the second subset of input bits of the current pixel.

23. The device of claim 20, wherein the previously processed pixel is a previously processed pixel that neighbors the current pixel.

24. The device of claim 20, wherein the means for determining that the first subset of input bits of the current pixel are same as the first subset of input bits of the previously processed pixel comprises:
means for accessing memory that stores respective first subsets of input bits of one or more previously processed pixels;
means for comparing the first subset of input bits of the current pixel to the respective first subsets of input bits of one or more previously processed pixels; and
means for determining the previously processed pixel having the same first subset of input bits as the first subset of input bits of the current pixel based on the comparison.

25. The device of claim 20, wherein the means for outputting the first subset of output bits of the previously processed pixel comprises:
means for determining an index into a memory that stores respective first subsets of output bits of one or more previously processed pixels corresponding to respective first subsets of input bits of the one or more previously processed pixels, wherein the index identifies the first subset of output bits of the previously processed pixel in the memory; and
means for outputting the first subset of output bits of the previously processed pixel based on the determined index.

26. A computer-readable storage medium storing instructions thereon that when executed cause one or more processors to:
determine that a first subset of input bits of a current pixel are same as a first subset of input bits of a previously processed pixel;
selectively bypass processing the first subset of input bits of the current pixel through a first pipeline based on the determination that the first subset of input bits of the current pixel are the same as the first subset of input bits of the previously processed pixel, wherein the first pipeline is configured to selectively process respective first subsets of input bits of pixels to generate respective first subsets of output bits;
output a first subset of output bits of the previously processed pixel as a first subset of output bits of the current pixel based on the determination that the first subset of input bits of the current pixel are the same as the first subset of input bits of the previously processed pixel, wherein the second pipeline is configured to process respective second subsets of the input bits of the pixels to generate respective second subsets of output bits; and
merge the first subset of output bits of the current pixel with a second subset of output bits of the current pixel generated through the second pipeline from a second subset of input bits of the current pixel.
